(19) United States
(12) Patent Application Publication
(10) Pub. No.: US 2025/0170866 A1
(43) Pub. Date: May 29, 2025

(54) RAPID RIDE HEIGHT ADJUSTMENT SYSTEM

(71) Applicant: Fox Factory, Inc., Duluth, GA (US)

(72) Inventors: Connor Randall, Poncha Springs, CO (US); Regan Woelfel, Scotts Valley, CA (US); Nick D'Orazio, Soquel, CA (US)

(21) Appl. No.: 18/782,339

(22) Filed: Jul. 24, 2024

Related U.S. Application Data
(60) Provisional application No. 63/604,110, filed on Nov. 29, 2023.

(51) Int. Cl. B60G 17/015

(52) U.S. Cl. CPC B60G 17/0152; B60G 2500/302

(57) ABSTRACT

A rapid ride height adjustment system is provided. The system includes a valve manifold, a pump coupled to the valve manifold, a reservoir coupled to the valve manifold, a control system coupled to the valve manifold, and a suspension of a vehicle coupled to the valve manifold. The control system regulates hydraulic fluid flow from the pump through the valve manifold and to the suspension to rapidly adjust a ride height of a vehicle. The control system may be programmed to have user determined rates of adjustment of the ride height of the vehicle. Another embodiment of the system includes a pump system coupled to a preload cylinder of a shock or a fork, and a dump valve coupled to the pump system and the preload cylinder. The dump valve opens to flow hydraulic fluid from the pressurized preload cylinder to rapidly adjust a ride height of a vehicle.

### CROSS REFERENCE TO RELATED APPLICATION(S)

This application claims priority to U.S. Provisional Patent Application entitled “RAPID RIDE HEIGHT ADJUSTMENT SYSTEM,” Ser. No. 63/604,110, filed Nov. 29, 2023, the disclosure of which is hereby incorporated entirely herein by reference.

### BACKGROUND OF THE INVENTION

### Technical Field

This invention relates generally to a system for adjusting ride height of a vehicle, and more particularly to a rapid ride height adjustment system.

### State of the Art

Vehicle ride height adjustments are beneficial in several different ways. These vehicle ride adjustments can be beneficial for ease of loading, clearing ground obstacles, improving fuel economy, and so forth. It is particularly beneficial if the height adjustments can happen in a rapid fashion.

Accordingly, there is a need for a rapid ride height adjustment system that enables ride height to be actively changed to provide these benefits of ease of loading, clearing ground obstacles, improving fuel economy and so forth.

### SUMMARY OF THE INVENTION

An embodiment includes a rapid ride height adjustment system comprising: a valve manifold; a pump coupled to the valve manifold; a reservoir coupled to the valve manifold; and a suspension of a vehicle coupled to the valve manifold, wherein the valve manifold controls hydraulic fluid flow between the pump and the and the suspension to rapidly adjust a ride height of a vehicle In embodiments, the system may further include an optional accumulator coupled to the valve manifold, wherein the valve manifold controls hydraulic fluid flow between the pump, the optional accumulator, and the shock and/or fork to rapidly adjust the ride height of the vehicle.

An embodiment includes a rapid ride height adjustment system comprising: a pump system coupled to a preload cylinder of a suspension; and a dump valve coupled to the pump system and the preload cylinder, wherein the dump valve opens to flow hydraulic fluid from the pressurized preload cylinder to rapidly adjust a ride height of a vehicle.

Another embodiment includes a method of rapid ride height adjustment of a vehicle, the method comprising: coupling a rapid ride height adjustment system to a suspension of a vehicle; activating the ride height adjustment system to adjust the suspension of the vehicle, thereby adjusting the ride height of the vehicle; and completing the adjustment of the ride height of the vehicle in less than three seconds.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a rapid ride height adjustment system according to an embodiment;

FIG. 2 is a diagrammatic view of a hydraulic pump for use in a rapid ride height adjustment system according to an embodiment; and

FIG. 3 is a flow chart of a method of rapid ride height adjustment of a vehicle according to an embodiment.

### DETAILED DESCRIPTION OF EMBODIMENTS OF THE INVENTION

As discussed above, embodiments of the present invention relate to a rapid ride height adjustment system that enables ride height to be actively changed to provide these benefits of ease of loading, clearing ground obstacles, improving fuel economy and so forth.

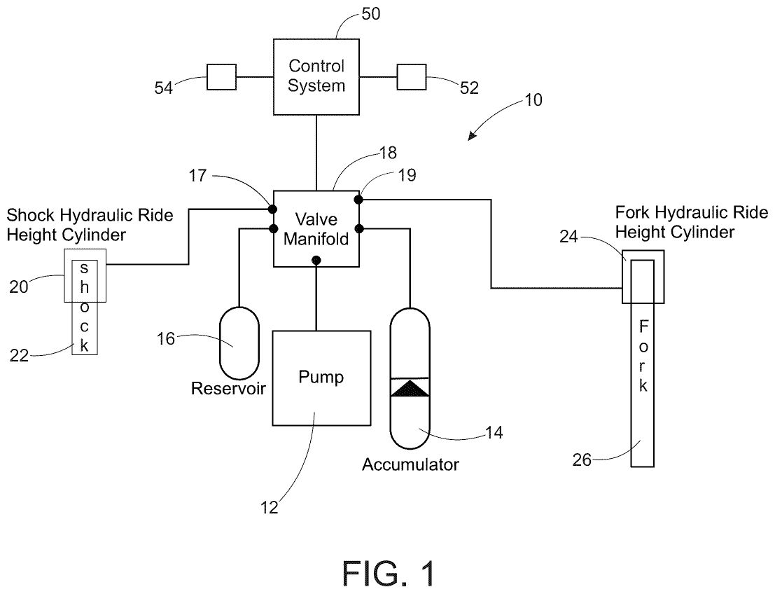

As shown in FIG. 1, an embodiment of a rapid ride height adjustment system 10 is depicted. The system 10 may include a pump 12, an optional accumulator 14, a reservoir 16, a valve manifold 18. The system 10 may include the valve manifold having a shock valve 17 coupled to a shock hydraulic ride height cylinder 20 of a shock 22 and/or a fork valve 19 coupled to a fork hydraulic ride height cylinder 24 of a fork 26. Further, the system 10 may include a control system 50. In operation, the hydraulic rapid ride height adjustment system 10 is capable of lowering and raising a vehicle in less than three seconds in some embodiments and in other embodiments, the system 10 is capable of controlling the rate of lowering and raising the vehicle through use of the control system 50.

The valve manifold 18 controls hydraulic fluid flow from the pump 12 (such as, but not limited to, a hydraulic pump powered by a motor, an air over hydraulic pump, ABS pump, a motor/lead screw mechanism to drive a piston that displaces hydraulic fluid, etc.) and a ride height system component coupled to suspension components such as the shock hydraulic ride height cylinder 20 of the shock 22 and the fork hydraulic ride height cylinder 24 of the fork 26. The control of hydraulic fluid flow functions to provide rapid ride height adjustment by lifting and lowering a spring hat (not shown) of the shock 22 or the fork 26 by use of a hydraulic ram or cylinder (not shown).

As indicated previously, the system 10 may operate to lower the vehicle rapidly, such as less than three seconds. In other embodiments, it may be desired to have the vehicle lower at a given rate or a user determined rate rather than lowering very rapidly (less than three seconds). However, certain challenges exist that conventional systems cannot overcome, such as the volume of oil is fairly low and pressure is high in a ride height controlling system, so any standard valve will lower the vehicle very quickly. The system 10 may comprise various configurations in order to change lowering rate. In one configuration, the valve manifold 18 may incorporate a manual bleed adjust (not shown) to control lowering rate. The manual bleed adjust operates to adjust or control a size of an orifice of the shock valve 17 and/or the fork valve 19. The adjustment or control of the orifice size operates to control the rate of hydraulic fluid flow to the shock 22 and/or fork 26. For example, an orifice diameter within the range of 010″-0.025″ may be utilized to lower between the ride height of the vehicle in a time between 2 seconds and 10 seconds, wherein the larger the orifice diameter, the faster the lowering rate is.

In another configuration, the shock valve 17 and the fork valve 19 may be flow control valves. The control system 50 may operate to pulse the valves 17 and 19 at a given frequency to rapidly turn it on/off. The frequency of the pulse to rapidly turn the valves 17 and 19 on/off then controls the rate of lowering the vehicle's ride height. The pulsing operates to slow the lowering rate because if the valve is simply opened, the ride height would adjust rapidly and pulsing the valve on and off interrupts the flow and thereby slows the lowering rate.

In another configuration, the shock valve 17 and the fork valve 19 may be small pilot flow control valves.

In yet another configuration, it may be desired to lower the vehicle ride height to a given travel, the shock valve 17 and the fork valve 19 may each be a proportional pressure relief valve. In a static situation (vehicle is not moving) the operation is simple wherein the control system 50 controls the current to the user's desired pressure of the system 10, which is correlated directly to travel and ride height of the vehicle. In a dynamic situation (vehicle is moving) the operation is more difficult than in a static situation. In the dynamic situation, the control system 50 may pulse the valve 17 and/or 19 quickly at a desired current correlating to a desired lowering rate. Pulsing the valve with current will lower the vehicle to the desired ride height at the desired lowering rate. The pulsing operates to slow the lowering rate because if the valve is simply opened, the ride height would adjust rapidly and pulsing the valve on and off interrupts the flow and thereby slows the lowering rate.

Further, the system 10 may incorporate an optional accumulator 14 that is also utilized for rapid ride height adjustment. The accumulator 14 is optional because the system 10 may operate without an accumulator 14 for rapid ride height adjustment, however, embodiments with the accumulator 14 operate to control noise in the system, maintain the proper pressure for functioning of the system and allow the pump utilized to be a smaller pump. Additional circuits can be added or removed depending on the number of suspension components desired.

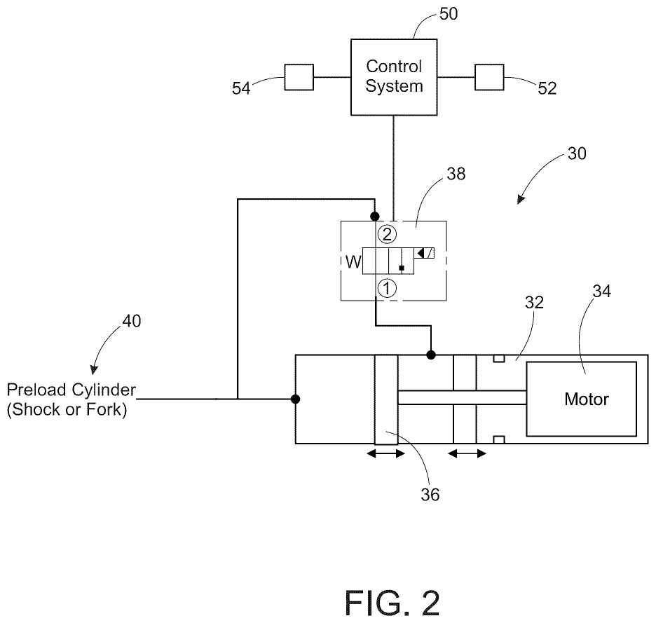

FIG. 2 depicts another embodiment of a rapid ride height adjustment system 30 is depicted. The system 30 may be a pump system 32 that utilizes a motor 34, a lead screw mechanism to drive a cylinder 36 that supplies hydraulic fluid to a preload cylinder 40, and a dump valve 38 to enable rapid lowering of a vehicle. When the dump valve 38 opens, flow from the pressurized preload cylinder is directed behind the piston 36 driven by the motor 34. The valve 38 is depicted as a two-position NC valve, however, other types may be utilized, such as, but not limited to, a main piston, etc. This system 30 may operate to drop the vehicle very fast, such as, less than three seconds. The motor 34 may then go back to the initial position where fluid can flow to the other side of the piston 36, and the motor 34 can then raise the vehicle to a desired height setting.

Embodiments of the system 10 or the system 30 may include one or more optional sensors 52 that provide feedback to a control system 50 to regulate flow from the valve manifold 18 or the dump valve 38 in order to set desired ride height, wherein the control system 50 is coupled to the valve manifold 18 or the dump valve 38 and the sensor 52 is coupled to the control system 50. This regulation of flow may be done automatically and actively with an algorithm operating on the control system 50 to maintain a desired ride height, or other modes. For example, fuel economy mode (lower ride height), rock crawling/offroad mode (higher ride height), entry or loading mode (when stopped lower ride height), auto leveling (maintains ideal ride height for changing loads), etc. Accordingly, in operation, the sensors 52 send signals to the control system 50, wherein the control system 50 processes the signals from the sensors 50 to determine the status of a vehicle. The control system 50 then operates, based on the status of the vehicle, to initiate flow of the hydraulic fluid in the system 10 to adjust the ride height of the vehicle. An example, without limitation, may include the sensors 52 sending a signal to the control system 50 regarding a speed of the vehicle, wherein the control system 50 determines that the vehicle has a stopped status and automatically operates to control flow of the hydraulic fluid through the system 10 to lower the ride height of the vehicle.

Additionally, the system 10 may include an optional position sensor 54 that can be incorporated as a zero point at a known displacement to ensure the encoder is tracking position correctly. In some cases, such as very high-speed hits, there is a risk of losing counts with an encoder of the control system 50, thereby causing drift in the measurement, and the position sensor 54 operates to ensure the encoder is tracking position correctly.

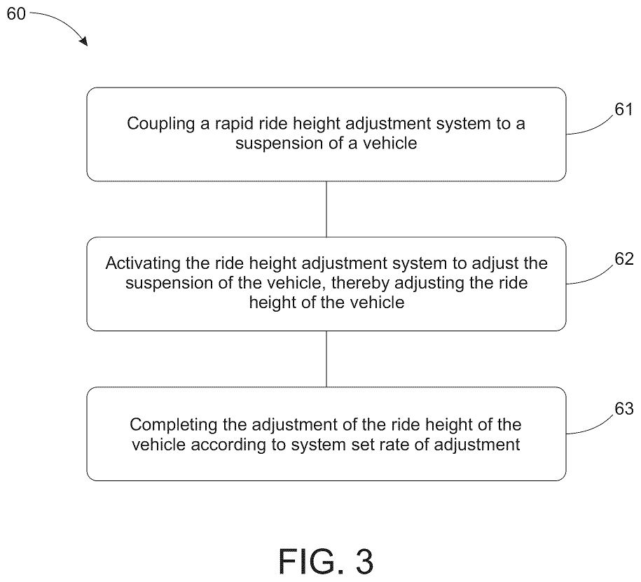

Another embodiment, as shown in FIG. 3, is a method 60 of rapid ride height adjustment of a vehicle. The method 60 comprises coupling a rapid ride height adjustment system to a suspension of a vehicle (Step 61); activating the ride height adjustment system to adjust the suspension of the vehicle, thereby adjusting the ride height of the vehicle (Step 62); and completing the adjustment of the ride height of the vehicle according to system set rate of adjustment (Step 63), wherein the system set rate of adjustment may be preset in the system or may be user defined rate settings. Conventional means of adjusting ride height are not capable of adjusting ride height at desired variable rates based on system settings or user input. The method includes the deployment of the system 10 on a vehicle and requires less volume of hydraulic fluid to be pumped and therefore requires configurations that cannot be accomplished by existing conventional systems.

In embodiments, understanding the position of the preload system in addition to ride height is desirable. The system 10 may function to obtain preload position of suspension components such as shocks 22 and forks 24, as well as ride height. In some embodiments, ride height may be obtained in several ways including, without limitation, using rotary pots on the suspension linkages, string pots, etc. In another embodiment, a pressure sensor (not shown) can be used to measure pressure in the system, which pressure correlates directly to shock travel. A running average may be used to obtain shock travel, and with a known motion ratio, the control system 50 may be programmed to use the obtained shock travel with the motion ratio to determine the travel of the shock. Another embodiment may include a linear potentiometer (not shown) that may be attached to the preload system to obtain travel of the preload system.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A rapid ride height adjustment system comprising:
a valve manifold;
a pump coupled to the valve manifold;
a reservoir coupled to the valve manifold;
a control system coupled to the valve manifold; and
a suspension of a vehicle coupled to the valve manifold, wherein the control system regulates hydraulic fluid flow from the pump through the valve manifold and to the suspension to rapidly adjust a ride height of a vehicle.

2. The system of claim 1, wherein the valve manifold comprises a proportional pressure relief valve, wherein the suspension is coupled to the proportional pressure relief valve of the valve manifold.

3. The system of claim 2, wherein the control system controls the current to adjust the system to a desired system pressure through the proportional pressure relief valve, when the vehicle is not moving.

4. The system of claim 2, wherein the control system pulses the proportional pressure relief valve quickly at a desired current correlating to a desired lowering rate, when the vehicle is moving.

5. The system of claim 1, wherein the suspension comprises a shock with a shock hydraulic ride height cylinder.

6. The system of claim 1, wherein the suspension comprises a fork with a fork hydraulic ride height cylinder.

7. The system of claim 1, wherein the suspension comprises at least one shock with a shock hydraulic ride height cylinder and at least one fork with a fork hydraulic ride height cylinder.

8. The system of claim 1, further comprising an accumulator coupled to the valve manifold, wherein the valve manifold controls hydraulic fluid flow between the pump, the accumulator and the suspension to rapidly adjust the ride height of the vehicle.

9. The system of claim 1, further comprising a sensor coupled to the control system, wherein the sensor provides vehicle status to the control system, wherein the control system automatically adjusts the ride height of the vehicle based on the vehicle status.

10. The system of claim 1, further comprising a position sensor coupled to the control system, wherein the position sensor operates as a zero point at a known displacement to ensure an encoder of the control system is tracking position correctly.

11. A rapid ride height adjustment system comprising:
a pump system coupled to a preload cylinder of a suspension; and
a dump valve coupled to the pump system and the preload cylinder, wherein the dump valve opens to flow hydraulic fluid from the pressurized preload cylinder to rapidly adjust a ride height of a vehicle.

12. The system of claim 11, wherein the suspension comprises a shock.

13. The system of claim 11, wherein the suspension comprises a fork.

14. The system of claim 11, wherein the suspension comprises at least one shock and at least one fork.

15. The system of claim 11, further comprising a control system coupled to the valve manifold, wherein the control system regulates flow from the valve manifold in order to adjust the ride height of the vehicle.

16. The system of claim 15, further comprising a sensor coupled to the control system, wherein the sensor provides vehicle status to the control system, wherein the control system automatically adjusts the ride height of the vehicle based on the vehicle status.

17. The system of claim 15, further comprising a position sensor coupled to the control system, wherein the position sensor operates as a zero point at a known displacement to ensure an encoder of the control system is tracking position correctly.

18. A method of rapid ride height adjustment of a vehicle, the method comprising:
coupling a rapid ride height adjustment system to a suspension of a vehicle;
activating the ride height adjustment system to adjust the suspension of the vehicle, thereby adjusting the ride height of the vehicle; and
completing the adjustment of the ride height of the vehicle according to system set rate of adjustment.

19. The method of claim 18, wherein the rapid ride height adjustment system comprises:
a valve manifold;
a pump coupled to the valve manifold;
a reservoir coupled to the valve manifold;
a control system coupled to the valve manifold; and
a suspension of a vehicle coupled to the valve manifold, wherein the control system regulates hydraulic fluid flow from the pump through the valve manifold and to the suspension to rapidly adjust a ride height of a vehicle.

20. The method of claim 18, wherein the rapid ride height adjustment system comprises:
a pump system coupled to a preload cylinder of a suspension; and
a dump valve coupled to the pump system and the preload cylinder, wherein the dump valve opens to flow hydraulic fluid from the pressurized preload cylinder to rapidly adjust a ride height of a vehicle.
